(19) United States
(12) Patent Application Publication
(10) Pub. No.: US 2004/0198413 A1
(43) Pub. Date: Oct. 7, 2004

(54) Wireless communication device with call management capability and method therefor

(76) Inventors: Gregory S. Smith, Ocean Ridge, FL (US); Hugo Normandin, Pompano Beach, FL (US); Un Tung Teng, Boynton Beach, FL (US)

Correspondence Address: Randi L. Dulaney, Motorola, Inc., Law Department, 8000 West Sunrise Boulevard, Fort Lauderdale, FL, 33322, US

(21) Appl. No.: 10/336,404

(22) Filed: Jan. 3, 2003

(51) Int. Cl. H04B 1/38; H04Q 7/20

(52) U.S. Cl. 455/550.1; 455/514

(57) ABSTRACT

A wireless communication device (102) initiates a plurality of calls using an operation mode (305. The wireless communication device includes a memory (245), a user interface (265), and a call manager application (270). A plurality of numbers (210) and a plurality of associated call types (212) are stored within the memory (245). The user interface (265) receives a user input (275) including a calling number. The call manager application (270) is programmed to compare the calling number to the plurality of numbers (210) stored in the memory (245), identify a call type associated with the calling number when the calling number is included within the plurality of numbers (210), and change the operation mode to the call type associated with the calling number.

### BACKGROUND OF THE INVENTION

1. Field of the Invention

This invention relates in general to wireless communication devices and more particularly to wireless communication devices having video and voice communication capability.

2. Description of the Related Art

Historically, wireless communication devices, such as cellular telephones and two way messaging devices, have had the ability to receive data and/or voice messages sent from a wireless communication system, and perform standard functions in response to message receipt such as storing the message, displaying the message, or alerting the user of receipt of the message. Data messages are typically a numeric message such as a phone number, or an alphanumeric message containing one unique piece of information such as “meeting in my office at 6:00 pm.”

The user is alerted of receipt of a new message by an audible alert or a vibratory alert. The display of many wireless communication devices today includes a message indicator for each message it has received and stored in memory. This message indicator allows a quick view for the user of how many messages are in the wireless communication device and also allows the user to quickly pick a message to view. The display further can include a call receipt message indicating to the user a new call is being received and/or the source of the new call.

Today, methods and systems have been developed in an attempt to satisfy the increasing demand for information, multimedia and other communication services on wireless communication devices. In particular, state of the art wireless communication technology today offers increased capacity and high-speed data applications up to 2 megabits. Recently wireless communication technologies have been implemented which integrate pico-micro and macrocellular technology and allows global roaming of wireless communication device. Further, wireless communication systems today are being designed for simultaneous transfer of speech, data, text, pictures, audio and video. For example, 3G (Third generation) wireless communication devices can provide a device user the capability to send images or to participate in live video conferencing. 3G networks can deliver the kind of high-speed wireless that supports video applications for utilization in MMS (multimedia messaging service). Adding a camera attachment to the wireless communication device facilitates the capability of the device to capture video. The captured video can then be wirelessly transmitted as a message via the wireless communication networks.

Some wireless communication devices today have the capability to make both voice and video calls. Typically, both types of calls are made from the same user interface (such as a keypad) with the user manually switching a call mode setting between voice and video calls. One drawback to this method is the reliance on the device user to manually switch the call mode setting. For example, during an emergency, the device user may not have the time to reset the call mode from video to voice. Alternatively, the device user may forget to set the call mode to voice and miss incoming voice calls.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an electronic block diagram of a wireless communication system in accordance with a preferred embodiment of the present invention.

FIG. 2 is an electronic block diagram of a wireless communication device for use within the wireless communication system of FIG. 1 in accordance with a preferred embodiment of the present invention.

FIG. 3 illustrates a categorized number memory for use within the wireless communication device of FIG. 2 in accordance with the present invention.

FIGS. 4 and 5 are flowcharts illustrating the operation of the wireless communication device in accordance with a preferred embodiment of the present invention.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

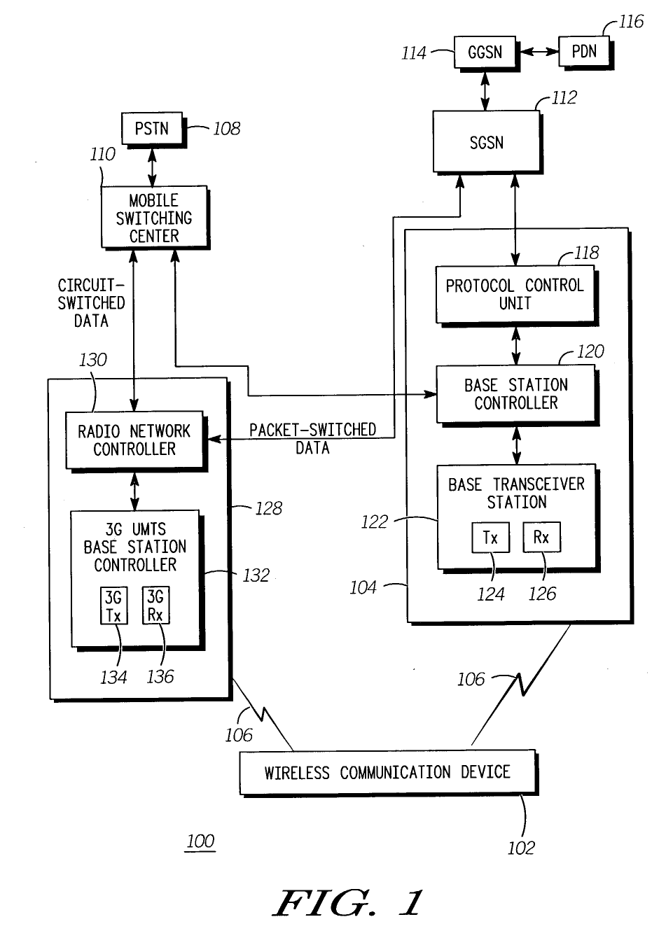

FIG. 1 is an electronic block diagram of a wireless communication system according to the present invention. As illustrated in FIG. 1, a wireless communication system 100 according to the present invention includes a wireless communication device 102, such as a wireless telephone device, capable of either second generation Global System for Mobile Communications (GSM) data interchange or third generation Universal Mobile Telephone System (UMTS) data interchange, or both. For example, the wireless communication device 102 transmits circuit-switched data through an air interface 106 to, and receives circuit-switched data through the air interface 106 from a second generation GSM General Packet Radio Service (GPRS) and Enhanced Data for Global Evolution (EDGE), GSM GPRS/EDGE radio access network 104. The circuit-switched data is transmitted by radio access network 104 from the wireless communication device 102 to a public switched telephone network (PSTN) 108, and from the public switched telephone network 108 to the wireless communication device 102, through a mobile switching center 110.

The wireless communication device 102 transmits packet-switched data through the air interface 106 to, and receives packet-switched data through the air interface 106 from the radio access network 104. The packet-switched data received from the wireless communication device 102 is transmitted by the radio access network 104 to a serving GPRS support node (SGSN) 112, which then transmits the packet-switched data to a gateway GPRS support node (GGSN) 114. The gateway GPRS support node 114 converts the packet-switched data from a domain associated with the radio access network 104 to a domain associated with a packet data network 116 and transmits the converted packet-switched data to packet data network 116.

Similarly, packet-switched data received from the packet data network 116 is converted by the gateway GPRS support node 114 from the domain associated with the packet data network 116 to the domain associated with the radio access network 104. The converted packet-switched data is then transmitted from the gateway GPRS support node 114 to the radio access network 104 through the GPRS support node 112. The radio access network 104 then transmits the packet-switched data to the wireless communication device 102 along the air interface 106.

The radio access network 104 preferably includes a protocol control unit 118, a base station controller 120, and a base transceiver station. The protocol control unit 118 interfaces between serving the GPRS support node 112 and the base station controller 120, which controls the packet-switched data that is transmitted between the packet data network 116 and the wireless communication device 102. The base station controller 120 controls one or more base transceiver stations, including the base transceiver station 122 located within the radio access network 104. The base transceiver station 122 includes a transmitter 124 and a receiver 126 for transmitting and receiving data between the wireless communication device 102 and the radio access network 104 along the air interface 106. The base station controller 120 transmits packet-switched data received from the packet data network 116 via the protocol control unit 118 to the base transceiver station 122, which then transmits the packet-switched data to the wireless communication device 102 along the air interface 106. In the same way, the base station controller 120 transmits packet-switched data received from the wireless communications device 102 via the base transceiver station 122 to the protocol control unit 118. The packet-switched data is then transmitted from the protocol control unit 118 to the packet data network 116 through the serving GPRS support node 112 and the gateway GPRS support node 114.

In addition to receiving packet-switched data exchanged between the packet data network 116 and the wireless communication device 102, the base station controller 118 receives circuit-switched data transmitted from the public switched telephone network 108 to the wireless communication device 102 through the mobile switching center 110, and transmits the circuit-switched data to the base transceiver station 122. The circuit-switched data is then transmitted from the base transceiver station 122 to the wireless communication device 102 along the air interface 106.

The base transceiver station 122 transmits circuit-switched data received from the wireless communication device 102 for transmission to the public switched telephone network 108 to the base station controller 120, and the circuit-switched data is then transmitted from the base station controller 120 to the mobile switching center 110, which then transmits the circuit-switched data to the public switch telephone network 108.

In this way, according to one embodiment of the present invention, wireless communication system 100 includes the wireless communication device 102, the radio access network 104 and the mobile switching center 110, with the wireless communication device 102 being capable of transmitting and receiving circuit-switched data along a circuit-switched data path between the wireless communication device 102 and the public switched telephone network 108 through the mobile switching center 110, the radio access network 104 and the air interface 106.

According to a second embodiment of the present invention, the wireless communication system 100 includes the wireless communication device 102, the radio access network 104, the serving GPRS support node 112 and the gateway GPRS support node 114, with the wireless communication device 102 being capable of transmitting and receiving packet-switched data along a packet-switched data path between the wireless communication device 102 and the packet data network 116 through the gateway GPRS support node 114, the serving GPRS support node 112, the radio access network 104 and the air interface 106.

According to a third embodiment of the present invention, the wireless communication system 100 includes the wireless communication device 102, the radio access network 104, the mobile switching center 110, the serving GPRS support node 112 and the gateway GPRS support node 114. As a result, according to the third embodiment of the present invention, the wireless communication device 102 is capable of transmitting and receiving circuit-switched data along a circuit-switched data path between the wireless communication device 102 and the public switched telephone network 108, through the mobile switching center 110 and the radio access network 104. In addition, the wireless communication device 102 is also capable of transmitting and receiving packet-switched data along a packet-switched path between the wireless communication device 102 and the packet data network 116 through the gateway GPRS support node 114, the serving GPRS support node 112, the radio access network 104 and the air interface 106.

As illustrated in FIG. 1, according to the present invention, the wireless communication device 102 transmits circuit-switched data through the air interface 106 to, and receives circuit-switched data through the air interface 106 from a third generation UMTS radio access network 128. Circuit-switched data received from the wireless communication device 102 is transmitted by the third generation UMTS radio access network 128 to the public switched telephone network 108 through the mobile switching center 110, and circuit-switched data received from the public switched telephone network 108 through the mobile switching center 110 is transmitted by the third generation UMTS radio access network 128 to the wireless communication device 102. The wireless communication device 102 transmits packet-switched data through the air interface 106 to, and receives packet-switched data through the air interface 106 from the third generation UMTS radio access network 128. The packet-switched data received by the third generation UMTS radio access network 128 from the wireless communication device 102 is transmitted by the third generation UMTS radio access network 128 to the serving GPRS support node 112, which then transmits to the packet-switched data to the gateway GPRS support node (GGSN) 114. The gateway GPRS support node 114 converts the packet-switched data from a domain associated with the third generation UMTS radio access network 128 to a domain associated with the packet data network 116 and transmits the converted packet-switched data to the packet data network 116.

Similarly, packet-switched data received from the packet data network 116 is converted by the gateway GPRS support node 114 from the domain associated with the packet data network 116 to the domain associated with the radio access network 104. The converted packet-switched data is then transmitted from the gateway GPRS support node 114 to the third generation UMTS radio access network 128 through the GPRS support node 112. The third generation UMTS radio access network 128 then transmits the packet-switched data to the wireless communication device 102 along the air interface 106.

Preferably, the third generation UMTS radio access network 128 includes a radio network controller 130 that is capable of discerning between the packet-switched data domain and the circuit-switched data domain to enable interface between the third generation UMTS radio access network 128 and both the packet data network 116 and the public switched telephone network 108. As a result, the third generation UMTS radio access network 128 interfaces with the serving GPRS support node 112 and the mobile switching center 110, with the radio network controller 130 controlling packet-switched data that is transmitted between the packet data network 116 and the wireless communication device 102 and circuit-switched data that is transmitted between the public switched telephone network 108 and the wireless communication device 102.

In particular, the radio network controller 130 interfaces with a third generation UMTS base station controller 132 located within the third generation UMTS radio access network 128 that includes a third generation UMTS transmitter 134 and a third generation UMTS receiver 136 for transmitting and receiving data transmitted between the wireless communication device 102 and the third generation UMTS radio access network 128 along the air interface 106. The third generation UMTS radio network controller 130 transmits packet-switched data received from the packet data network 116, through the serving GPRS support node 112 and the gateway GPRS support node 114, to the third generation UMTS base station controller 132, which then transmits the packet-switched data to the wireless communication device 102 along the air interface 106. The third generation UMTS radio network controller 130 transmits packet-switched data received from the wireless communication device 102 via the third generation UMTS base station controller 132 to the packet data network 116 through the serving GPRS support node 112 and the gateway GPRS support node 114. In the same way, the third generation UMTS radio network controller 130 transmits circuit-switched data received from the public switched telephone network 108, through the mobile switching center 110, to the third generation UMTS base station controller 132, which then transmits the circuit-switched data to the wireless communication device 102 along the air interface 106. Finally, the third generation UMTS radio network controller 130 transmits circuit-switched data received from the wireless communication device 102 via the third generation UMTS base station controller 132 to the public switched telephone network 108 through mobile switching center 110.

In this way, according to a fourth embodiment of the present invention, the wireless communication system 100 includes the wireless communication device 102, the third generation UMTS radio access network 128 and the mobile switching center 110, with the wireless communication device 102 being capable of transmitting and receiving circuit-switched data along a circuit-switched data path between the wireless communication device 102 and the public switched telephone network 108 through the mobile switching center 110, the third generation UMTS radio access network 128 and the air interface 106. According to a fifth embodiment of the present invention, the wireless communication system 100 includes the wireless communication device 102, the third generation UMTS radio access network 128, the serving GPRS support node 112 and the gateway GPRS support node 114, with the wireless communication device 102 being capable of transmitting and receiving packet-switched data along a packet switched data path between the wireless communication device 102 and the packet data network 116 through the gateway GPRS support node 114, the serving GPRS support node 112, the third generation UMTS radio access network 128 and the air interface 106.

According to a sixth embodiment of the present invention, the wireless communication system 100 includes the wireless communication device 102, the third generation UMTS radio access network 128, the mobile switching center 110, the serving GPRS support node 112 and the gateway GPRS support node 114. As a result, according to the sixth embodiment of the present invention, the wireless communication device 102 is capable of transmitting and receiving circuit-switched data along a circuit-switched data path between the wireless communication device 102 and the public switched telephone network 108, through the mobile switching center 110 and the third generation UMTS radio access network 128, and is also capable of transmitting and receiving packet-switched data along a packet-switched path between the wireless communication device 102 and the packet data network 116 through the gateway GPRS support node 114, the serving GPRS support node 112, the third generation UMTS radio access network 128 and the air interface 106.

According to a seventh embodiment of the present invention, the wireless communications system 100 includes the wireless communication device 102, the radio access networks 104 and 128, the mobile switching center 110, the serving GPRS support node 112 and the gateway GPRS support node 114. According to the seventh embodiment of the present invention, the wireless communication device 102 is capable of transmitting and receiving circuit-switched data along a circuit-switched data path between the wireless communication device 102 and the public switched telephone network 108, through the mobile switching center 110 and the radio access network 104. In addition, the wireless communication device 102 is also capable of transmitting and receiving packet-switched data along a packet-switched path between the wireless communication device 102 and the packet data network 116 through the gateway GPRS support node 114, the serving GPRS support node 112, the radio access network 104 and the air interface 106. Furthermore, according to the seventh embodiment of the present invention, the wireless communication device 102 is capable of transmitting and receiving circuit-switched data along a circuit-switched data path between the wireless communication device 102 and the public switched telephone network 108, through the mobile switching center 110 and the third generation UMTS radio access network 128. Further, the wireless communication device 102 is also capable of transmitting and receiving packet-switched data along a packet-switched path between the wireless communication device 102 and the packet data network 116 through the gateway GPRS support node 114, the serving GPRS support node 112, the third generation UMTS radio access network 128 and the air interface 106.

As a result, the present invention provides a multiple air interface, corresponding to the seven embodiments described above, that enables network access by the wireless communication device 102 along either the circuit-switched path or the packet-switched path from the wireless communication device 102 to the public switched telephone network 108 and the packet data network 116, respectively, or both, and through either second generation GSM GPRS/EDGE radio access network 104 or third generation UMTS radio access network 128, or both.

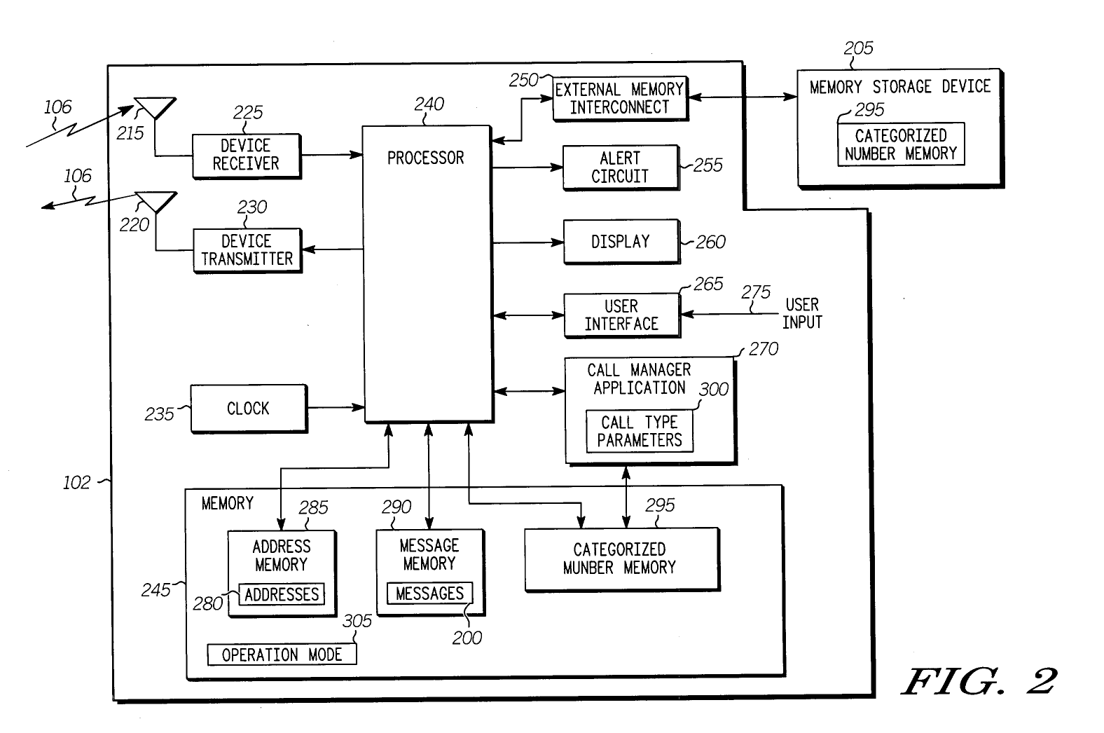

FIG. 2 is an electronic block diagram of the wireless communication device 102 for use within the wireless communication system 100 of FIG. 1 in accordance with a preferred embodiment of the present invention. It will be appreciated by one of ordinary skill in the art that the wireless communication device 102 in accordance with the present invention, can be a mobile cellular telephone, a mobile radio data terminal, a mobile cellular telephone having an attached data terminal, or a two way messaging device. In the following description, the term “wireless communication device” refers to any of the devices mentioned above or an equivalent.

As illustrated in FIG. 2, the wireless communication device 102 includes a first antenna 215, a second antenna 220, a device receiver 225, a device transmitter 230, a clock 235, a processor 240, a memory 245, an alert circuit 255, a display 260, a user interface 265, and a call manager application 270.

The first antenna 215 intercepts transmitted signals received via the air interface 106. The first antenna 215 is coupled to the device receiver 225, which employs conventional demodulation techniques for receiving the communication signals via the air interface 106. Coupled to the device receiver 225, is the processor 240 utilizing conventional signal-processing techniques for processing received messages. Preferably, the processor 240 is similar to the MC68328 micro-controller manufactured by Motorola, Inc. of Schaumburg, Ill. It will be appreciated by one of ordinary skill in the art that other similar processors can be utilized for the processor 240, and that additional processors of the same or alternative type can be utilized as required to handle the processing requirements of the processor 240. The processor 240 decodes an address in the demodulated data of the received message, compares the decoded address with one or more addresses 280 stored in an address memory 285 of the memory 245; and when a match is detected, proceeds to process the remaining portion of the received message.

To perform the necessary functions of the wireless communication device 102, the processor 240 is coupled to the memory 245, which preferably includes a random access memory (RAM), a read-only memory (ROM), and an electrically erasable programmable read-only memory (EEPROM)(not shown). The memory 245 includes the address memory 285, a message memory 290, and a categorized number memory 295.

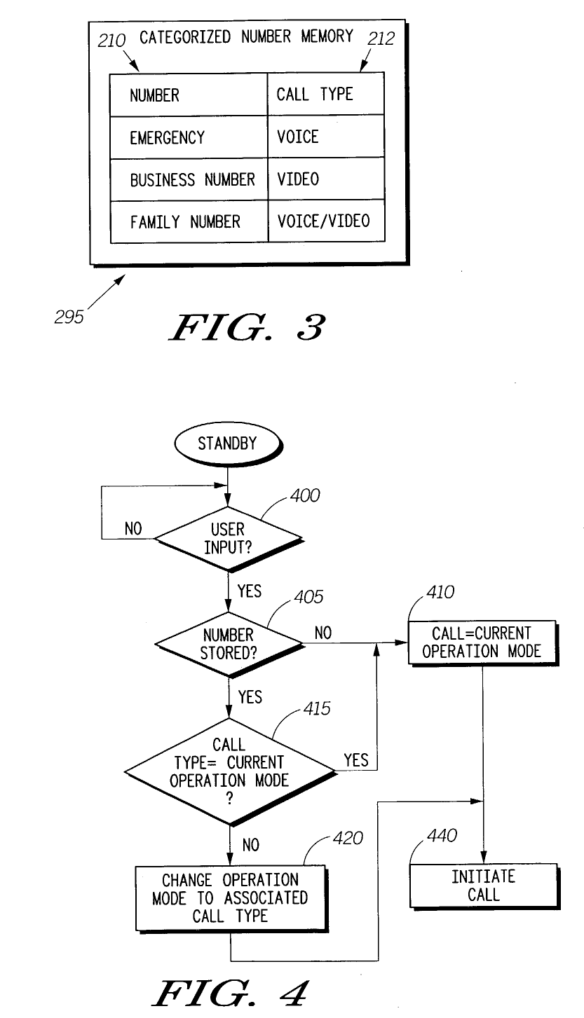

FIG. 3 illustrates a preferred embodiment of the categorized number memory 295 in accordance with the present invention. As illustrated, the categorized number memory 295 preferably stores a plurality of numbers 210 and a plurality of associated call types 212. For example, the emergency number 911 can be stored with an associated voice call type. Similarly, a business conference number can be stored with an associated video call type. It will be appreciated by those of ordinary skill in the art that the associated call type can be a combination of one or more call types such as a combination of video and voice calls. The call type, in accordance with the present invention, can identify whether the call is to be processed through either the second generation GSM GPRS/EDGE radio access network 104 or third generation UMTS radio access network 128, or both of FIG. 1. The call type can further include the connection type (wide area network, short range wireless, infrared data association (IrDA), Universal Serial Bus (USB), or serial). If a wide or local area network was used for communication, the call type can further include routing information that can be converted to an IPv4/MAC or IPv6 address. A user friendly name such as URL, Uniform Resource Identifiers (URI), phone number or other where a Domain Name Server (DNS) can be used to access a database to obtain the routable information (IP addressing).

Referring back to FIG. 2, once the processor 240 has processed one or more received messages 200, it stores the decoded message in the message memory 290 of the memory 245. It will be appreciated by one of ordinary skill in the art that the message memory 290, in accordance with the present invention, can be a voicemail box or a group of memory locations in a data storage device. In the following description, the term “message memory” refers to any of the memory means mentioned above or an equivalent.

In one embodiment, the wireless communication device 102 includes an external memory interconnect 250 for operatively connecting a memory storage device 205 to the wireless communication device 102. The external memory interconnect 250 can, for example, comprise a structure for physically engaging external contacts on the memory storage device 205 so that the memory storage device 205 is directly connected to the wireless communication device 102. It will be appreciated by one of ordinary skill in the art that the external memory interconnect 250 can also be a wireless connection such as an infrared, Bluetooth or radio frequency interface. When the external memory interconnect 250 is connected to the memory storage device 205, the wireless communication device 102 can access a plurality of memory information from the memory storage device 205. For example, the memory storage device 205 can include the categorized number memory 295 as illustrated in FIG. 3 and described previously herein.

The memory storage device 205, for example, can be a subscriber identification module (SIM) card. A SIM card is an electronic device typically including a microprocessor unit and a memory suitable for encapsulating within a small flexible plastic card. The SIM card additionally includes some form of interface for communicating with an external device or system. The SIM card can be used to transfer a variety of information from/to the wireless communication device 102 and/or any other compatible device.

Upon receipt and processing of a message, the processor 240 preferably generates a command signal to the alert circuit 255 as a notification that the message 200 has been received and stored. The alert circuit 255 can include a speaker (not shown) with associated speaker drive circuitry capable of playing melodies and other audible alerts, a vibrator (not shown) with associated vibrator drive circuitry capable of producing a physical vibration, or one or more LEDs (not shown) with associated LED drive circuitry capable of producing a visual alert. It will be appreciated by one of ordinary skill in the art that other similar alerting means as well as any combination of the audible, vibratory, and visual alert outputs described can be used for the alert circuit 255.

Upon receipt and processing of a message, the processor 240 preferably also generates a command signal to the display 260 to generate a visual notification of the receipt and storage of the message. When the display 260 receives the command signal from the processor 240 that the message has been received and stored in the memory 245, a message indication is displayed. The message indication, for example can be the activation of one of a plurality of message icons on the display 260. The display 260 can be, for example, a liquid crystal display utilized to display text and graphics. It will be appreciated by one of ordinary skill in the art that other similar displays such as cathode ray tube displays can be utilized for the display 260.

The wireless communication device 102 preferably further includes the clock 235. The clock 235 provides timing for the processor 240. The clock 235 can include the current time for use in the operation of the wireless communication device 102. The clock 235 also provides a source for timing of feature enhancements such as active and inactive periods of operation or periods of alerting.

In a preferred embodiment, the wireless communication device 102 includes the call manager application 270. The call manager application 270 can be hard coded or programmed into the wireless communication device 102 during manufacturing, can be programmed over-the-air upon customer subscription, or can be a downloadable application. It will be appreciated that other programming methods can be utilized for programming the call manager application 270 into the wireless communication device 102. It will be further appreciated by one of ordinary skill in the art that the call manager application 270 can be hardware circuitry within the wireless communication device 102.

Preferably, the user interface 265 is coupled to the processor 240. The user interface 265 can be one or more buttons used to generate a button press, a series of button presses, a voice response from the device user, or some other similar method of manual response initiated by the device user of the wireless communication device 102. The processor 240, in response to receiving a user input 275 via the user interface 265, such as a device user depressing a button or series of buttons, or in response to receipt of a message, initiates a user input signal to the call manager application 270. The call manager application 270, in response to the user input signal including a calling number, accesses a plurality of call number information stored in the categorized number memory 295 for use in operation of the call manager application 270. For example, when the device user enters the calling number “911” and presses SEND using the user interface 265, the call manager application 270 accesses the categorized number memory 295 in either or both the memory 245 and/or the memory storage device 205. When the number “911” is stored as an emergency phone number with a voice call type associated with it, the call manager application 270 sends an application signal to the processor 240 notifying the processor 240 that the call type for this call is a voice call.

The device transmitter 230 is coupled to the processor 240 and is responsive to one or more commands from the processor 240. When the device transmitter 230 receives a command from the processor 240, the device transmitter 230 sends a signal from the second antenna 220 to the air interface 106 for communication within the wireless communication system 100. For example, the device transmitter 230 initiates a voice call via the air interface 106 when the number “911” is identified as described above.

In an alternative embodiment (not shown), the wireless communication device 102 includes one antenna performing the functionality of the first antenna 215 and the second antenna 220. Further, the wireless communication device 102 alternatively includes a transceiver circuit (not shown) performing the functionality of the device receiver 225 and the device transmitter 230. It will be appreciated by one of ordinary skill in the art that other similar electronic block diagrams of the same or alternate type can be utilized for the wireless communication device 102.

In an alternate embodiment of the present invention, the call manager application 270 is programmed to include one or more call type parameters 300 for identification of the call type to utilize with a telephone number entered using the user interface 265. Each call type parameter can be a calculation, an equation, a function, or a comparison value. The one or more call type parameters can be changed in response to receipt of a programming message, in response to a timer timeout, or in response to a direct reprogramming of the call manager application 270. As an example, the call type parameter can be a particular button press or series of button presses by the device user using the user interface 265. The user interface 265 can include an emergency red button and when the telephone number entered is followed by the pressing of the emergency button, the call manager application 270 processes the call using a voice call type.

It will be appreciated by those of ordinary skill in the art that the wireless communication device 102 includes a current operation mode 305 preferably stored in the memory 245. The current operation mode 305 identifies the call type in use by the wireless communication device 102 for communicating within the wireless communication system 100. The call manager application 270 informs the processor 240 to utilize the call type of the current operation mode 305 when the number inputted to the user interface 265 is not included in the categorized number memory 295. In accordance with the present invention, when the number inputted to the user interface 265 is included in the categorized number memory 295, the call type associated with that stored number overrides the current operation mode 305. For example, when the current operation mode 305 is set to a voice call mode, when the user enters the emergency number “911” and presses SEND on the user interface 265, and this number is stored within the categorized number memory 295 with an associated voice call type, the wireless communication device 102 will make a voice call. Similarly, when the current operation mode 305 is set to a video call mode, and this number is stored within the categorized number memory 295 with an associated voice call type, when the user enters the emergency number “911” and presses SEND on the user interface 265, the wireless communication device 102 will change the operation mode to a voice call mode and send a voice call. When “911” is not stored within the categorized number memory 295 with an associated voice call type, the wireless communication device 102 utilizes the current operation mode 305, which would initiate a video call in this last example.

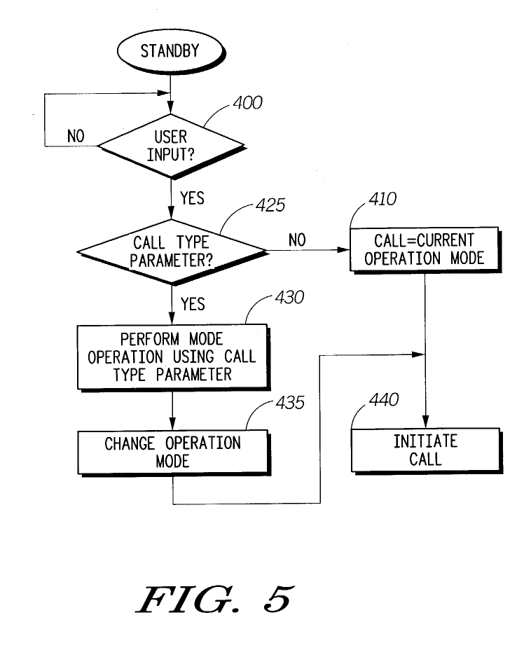

FIG. 4 is a flowchart illustrating one embodiment of the operation of the wireless communication device 102 in accordance with the present invention. The operation begins with the wireless communication device 102 in standby operation. Next, at Step 400, the process queries for receipt of the user input 275 to the user interface 265. The user input 275, for example, can be the pressing of a series of buttons to form a desired telephone number to be dialed on the wireless communication device 102. When no user input is detected, the process cycles back and periodically checks for the user input 275. In Step 405, when the user input 275 is detected in Step 400, the process next compares the number associated with the user input 275 to the plurality of numbers 210 stored in the categorized number memory 295. Those skilled in the art will appreciate that the number can be stored in the memory 245, the memory storage device 205, or any combination. In Step 410, when the number associated with the user input 275 is not stored within the plurality of numbers 210, the current operation mode is maintained. Next, in Step 440, the wireless communication device 102 initiates a call using the current operation mode 305. In Step 415, when in Step 405 it is determined that the number associated with the user input 275 is stored in within the plurality of numbers 210, the process compares the associated call type stored with the number with the current operation mode 305. When the associated call type is the same as the current operation mode 305, the process continues to Step 410. In Step 420, when the associated call type is not the same as the current operation mode 410, the operation mode is changed to the associated call type. Next, in Step 440, the wireless communication device 102 initiates a call using the new operation mode.

FIG. 5 is a flowchart illustrating one embodiment of the operation of the wireless communication device 102 in accordance with the present invention. The operation begins with the wireless communication device 102 in standby operation. Next, at Step 400, the process queries for receipt of the user input 275 to the user interface 265. The user input 275, for example, can be the pressing of a series of buttons to form a desired telephone number to be dialed on the wireless communication device 102. When no user input is detected, the process cycles back and periodically checks for the user input 275. In Step 425, when the user input 275 is detected, the process determines whether or not the user input 275 includes one or more call type parameters 300. When no call type parameter is included within the user input 275, the process continues at Step 410. In Step 410, the current operation mode is maintained. Next, in Step 440, the wireless communication device 102 initiates a call using the current operation mode 305. When one or more call type parameters 300 are associated with the user input 275, the process continues at Step 430 wherein the one or more call type parameters 300 are utilized to perform one or more operations on the current operation mode 305. Next, in Step 435, the operation mode is changed to the associated call type according to the operations performed in Step 430. Next, in Step 440, the wireless communication device 102 initiates a call using the new operation mode.

Although the invention has been described in terms of preferred embodiments, it will be obvious to those skilled in the art that various alterations and modifications can be made without departing from the invention. Accordingly, it is intended that all such alterations and modifications be considered as within the spirit and scope of the invention as defined by the appended claims.

What is claimed is:

1. A wireless communication device having an operation mode for initiating one or more calls within a wireless communication system, the wireless communication device comprising:
a memory for storing a plurality of numbers and a plurality of associated call types;
a user interface for receiving a user input including a calling number; and
a call manager application coupled between the user interface and the memory, wherein the call manager application is programmed to:
compare the calling number to the plurality of numbers stored in the memory,
identify a call type associated with the calling number when the calling number is included within the plurality of numbers, and
change the operation mode to the call type associated with the calling number.

2. A wireless communication device as recited in claim 1 further comprising:
a device transmitter for initiating a call using the call type associated with the calling number.

3. A wireless communication device as recited in claim 1 wherein the memory comprises a memory storage device connected to the wireless communication device via an external memory interconnect.

4. A wireless communication device having an operation mode for initiating one or more calls within a wireless communication system, the wireless communication device comprising:
a user interface for receiving a user input including a call type parameter; and
a call manager application coupled to the user interface, wherein the call manager application is programmed to:
identify a call type associated with the call type parameter, and
change the operation mode to the call type associated with the call type parameter.

5. A method of call management within a wireless communication device, the method comprising:
operating using a current operation mode;
entering a user input including a calling number;
comparing the calling number to a plurality of numbers stored in the memory;
identifying a call type associated with the calling number when the calling number is included within the plurality of numbers; and
changing the operation mode to the call type associated with the calling number.

6. A method of call management within a wireless communication device, the method comprising:
initiating a user input including one or more call type parameters;
performing one or more operations using the one or more call type parameters;
changing the operation mode to a new operation mode with the associated call type according to the one or more operations performed; and
initiating a call using the new operation mode.
